(19) United States
(12) Patent Application Publication
(10) Pub. No.: US 2015/0163072 A1
(43) Pub. Date: Jun. 11, 2015

(54) Virtual Port Extender

(71) Applicant: Broadcom Corporation, Irvine, CA (US)

(72) Inventors: Mohan KALKUNTE, Saratoga, CA (US); Venkateshwar BUDUMA, San Jose, CA (US)

(73) Assignee: Broadcom Corporation, Irvine, CA (US)

(21) Appl. No.: 14/529,471

(22) Filed: Oct. 31, 2014

Related U.S. Application Data
(60) Provisional application No. 61/912,245, filed on Dec. 5, 2013.

(51) Int. Cl. H04L 12/46; H04L 12/741; H04L 12/931

(52) U.S. Cl. CPC H04L 12/4633; H04L 49/70; H04L 45/745

(57) ABSTRACT

A system, method, and a computer readable medium for transmitting a packet in a network are provided. An overlay network is a virtual network that transmits a packet between a plurality of controlling bridges and a plurality of port extenders. A port extender connects to multiple servers in the server rack and a controlling bridge transmits packets over a network outside of the servers in the server rack. A mapping between virtual ports of a port extender and a controlling bridge is provided, such that the mapping enables the packet transmission in the overlay network.

### CROSS REFERENCE TO RELATED APPLICATIONS

This application claims the benefit of U.S. Provisional Application No. 61/912,245 filed on Dec. 5, 2013, which is incorporated by reference herein in its entirety.

### BACKGROUND

1. Field

The embodiments relate to an overlay network, including an overlay network between port extenders and controlling, bridges.

2. Related Art

Computer networks suitable for cloud computing require a scalable network infrastructure that hosts traditional and distributed applications. These networks may be implemented within data centers, and also as networks that send and transmit data over the Internet or the World Wide Web.

Data centers and other networks include multiple server racks that store multiple servers. These servers may host multiple virtual machines. Servers also include multiple network cards that include multiple ports, such that each port corresponds to a unique internet protocol (IP) address. Virtual machines use these ports to send and receive data traffic encapsulated in packets over a network. To manage available ports and aggregate data traffic, multiple servers within a rack physically connect to a port extender. The port extender aggregates packets from multiple servers and physically connects to a controlling bridge using a single port. In this way, packets from multiple servers within the server rack are transmitted from a single controlling bridge to other servers within the network. Similarly, when a controlling bridge receives packets from other servers within a network, the controlling bridge forwards the packets to the port extender via a physical link. In turn, a port extender uses its multiple ports that connect the port extender to servers within the server rack and distributes the packets to the respective servers.

### BRIEF SUMMARY

A system, method, and a computer readable medium for transmitting a packet in a network are provided. An overlay network is a virtual network that transmits a packet between a plurality of controlling bridges and a plurality of port extenders. A port extender connects to multiple servers in the server rack and a controlling bridge transmits packets over a network outside of the servers in the server rack. A mapping between virtual ports of a port extender and a controlling bridge is provided, such that the mapping enables the packet transmission in the overlay network.

Further features and advantages of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

FIG. 1 is a block diagram of a network, according to an embodiment.

FIG. 2A is a block diagram of an overlay network between port extenders and controlling bridges, according to an embodiment.

FIG. 2B is a block diagram of physical connections and virtual tunnels between port extenders and controlling bridges, according to an embodiment.

FIG. 3 is a block diagram of a port extender that transmits a packet over an overlay network, according to an embodiment.

FIG. 4 is a flowchart of a method for transmitting a packet over an overlay network, according to an embodiment.

FIG. 5 is a block diagram of a controlling bridge that transmits a packet over an overlay network, according to an embodiment.

FIG. 6 is a flowchart of a method for transmitting a packet over an overlay network, according to an embodiment.

FIG. 7 is an example computer system in which the embodiments can be implemented.

The embodiments will be described with reference to the accompanying drawings. Generally, the drawing in which an element first appears is typically indicated by the leftmost digit(s) in the corresponding reference number.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments” does not require that all embodiments include the discussed feature, advantage or mode of operation. Alternate embodiments may be devised without departing from the scope of the disclosure, and well-known elements of the disclosure may not be described in detail or may be omitted so as not to obscure the relevant details. In addition, the terminology used herein is for the purpose of describing particular embodiments only and is not intended to be limiting of the disclosure. For example, as used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

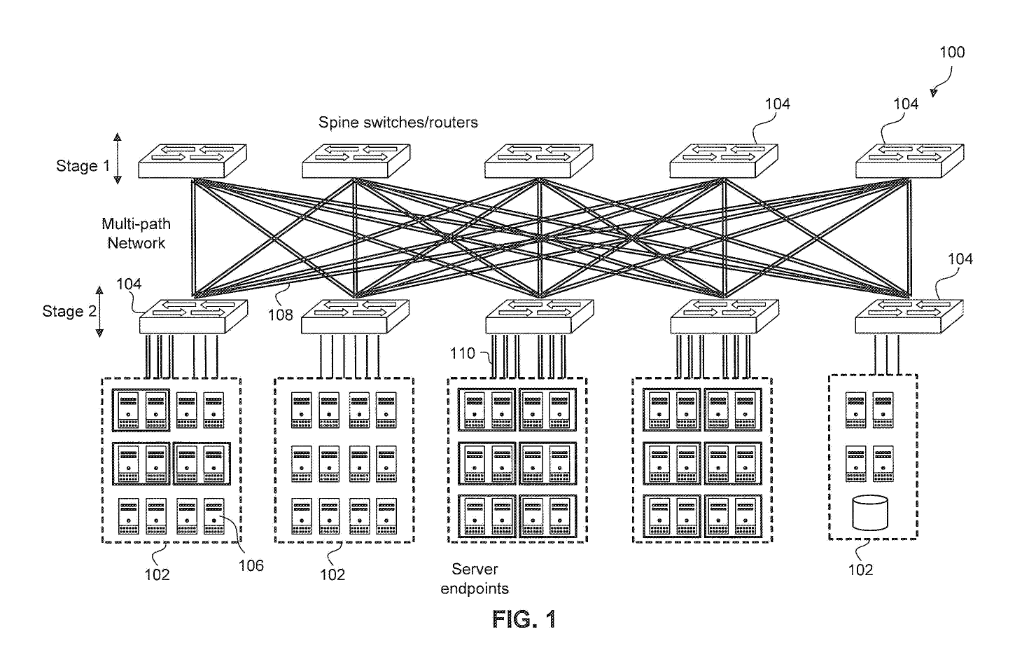

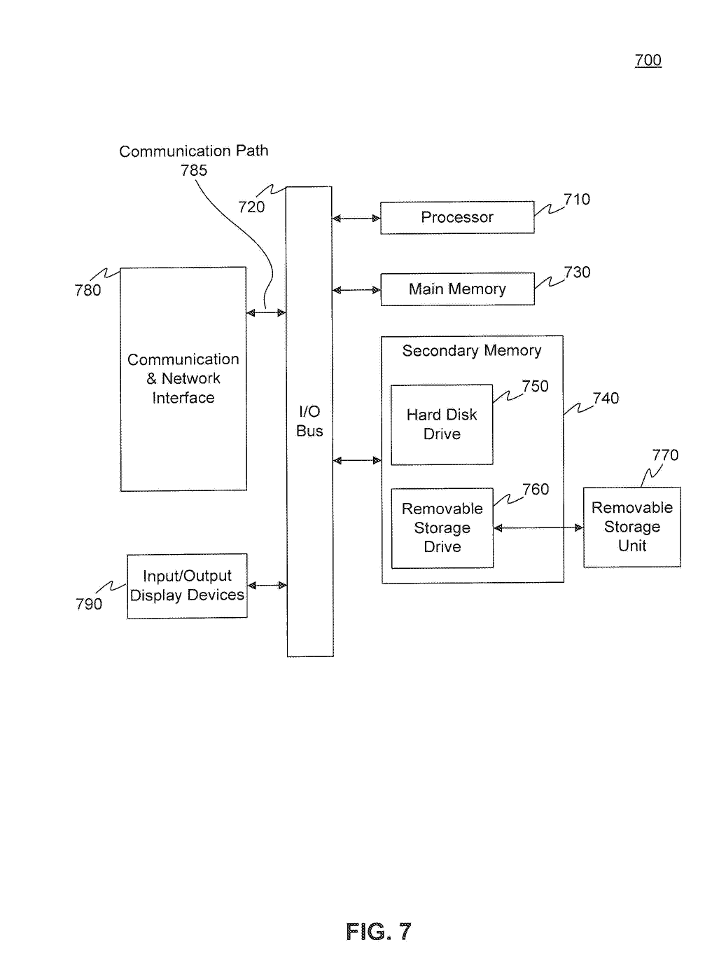

FIG. 1 is a block diagram of a network 100, according to an embodiment. Example network 100 connects multiple servers within a data center, though the implementation is not limited to this embodiment. A data center is a facility that includes multiple server racks 102 that include multiple servers 106. Servers 106 are computers that host computer systems and may include virtual machines that store data, execute applications, provide services to other computing devices, such as mobile devices, desktop devices, laptop devices, set-top boxes, other servers, etc. Example computing device that may function as server 106 is included in FIG. 7.

Network 100 allows data traffic to travel between servers 106 in the same or different server racks 102. Example network 100 may be a local area network (LAN), wide area network (WAN), storage area network (SAN), etc. Network 100 may be a mesh network, though an implementation is not limited to this embodiment.

In an embodiment, network 100 includes multiple switches 104 that are connected by links 108. Switches 104 and links 108 connect servers 106 located in the same or different server racks 102 and allow for data to travel among servers 106. When data traffic travels from one switch 104 to another switch 104 via link 108, the traversal is considered a network hop. In an embodiment, data may travel from server 106 to the first switch 104 and then via individual hops though multiple switches 104 until it reaches a destination, which is another server 106 that receives the data. Each server 106 and its components or applications may typically act as both a source and a destination. A hop is a data path increment between devices in a network, i.e. between switches or routers.

In an embodiment, network 100 may be a multi-stage network. In a multi-stage network, switches 104 at stage 2 connect to servers 106 using one or more links over network ports 110. Packets then travel from switch 104 at stage 2 to switches 104 at stage 1, or until packets reaches the “spine,” which is the topmost stage in network 100, and then travels down to a destination. For instance, in example FIG. 1, stage 1 is the spine.

In an embodiment, network 100 may be composed of routers instead of switches. For the purposes of this disclosure, there is no distinction in the operational models of a router verses a switch. Routers may connect network 100 with other, same or different, networks for the inter-network data communication. Both switches 104 and routers may be collectively referred to as devices that propagate packets in network 100.

In an embodiment, network 100 may transmit packets using various data protocols. Example protocols may include Transmission Control Protocol and Internet Protocol (TCP/IP), User Datagram Protocol (UDP), and Hypertext Transfer Protocol (HTTP).

Switches 104 route data from a source to a destination via multiple hops. A source is server 106 that generates packets and a destination is a sever 106 that receives packets. In an embodiment, switches 104 may route data using different layers in the Open System Interconnection (OSI) model, which is known to a person skilled in the relevant art. Example layers that are utilized in packet routing may be a data-link layer (layer 2) or a network layer (layer 3), though the implementation is not limited to these embodiments. To transmit packets using a data-link layer, packets include a “media access control address” (MAC address) that is associated with a host computing device, such as server 106. The MAC address is a hardware-based address that is attached to a network interface card within server 106 and cannot be changed by other components within network 100. To transmit packets using a MAC address, the MAC address of a source and destination servers 106 is included in the packet. Switches 104 within network 100 then access and use the MAC addresses to determine the route for the packet.

To transmit packets using a network layer, packets include IP addresses of source and destination servers 106. The IP addresses may be encapsulated within packets, such as, in the packet header, and are then accessed by switches 104 that propagate packets through network 100.

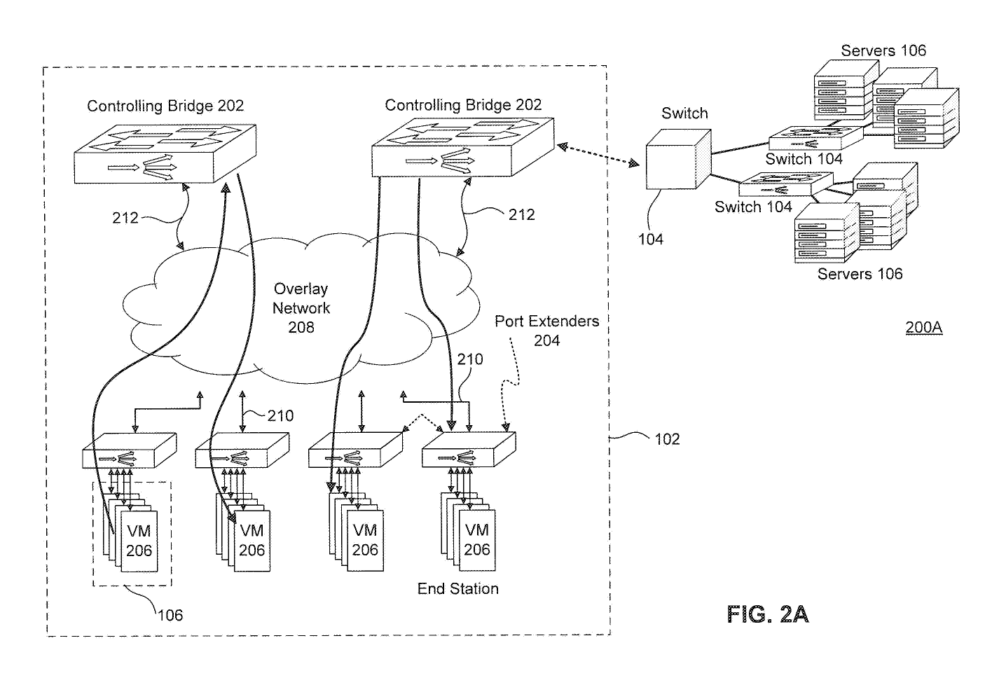

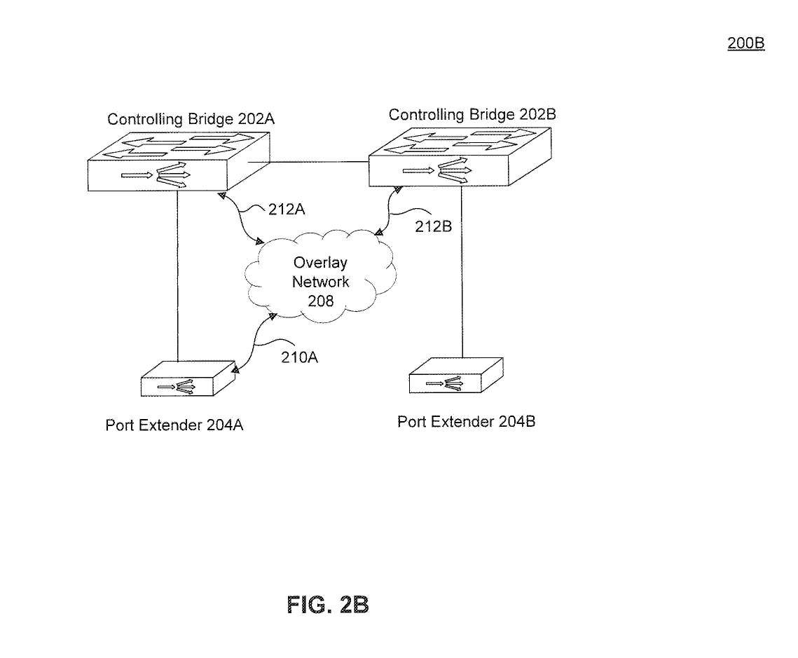

In an embodiment, network ports 110 may connect a controlling bridge to network 100. A controlling bridge may be a piece of hardware that includes a port for receiving packets associated with a particular set of servers 106 within server rack 102. Conventionally, a controlling bridge physically connects to a single port extender that “extends” the port of a controlling bride to multiple ports associated with servers, in a “one” to “many” relationship, or to multiple other port extenders, that then connect to multiple servers 106. However, in a preferred embodiment, controlling bridges may also be connected to multiple port extenders within an overlay network. FIG. 2A is a block diagram 200 of an overlay network between port extenders and controlling bridges, according to an embodiment.

As discussed above, server rack 102 may include servers 106 that use a controlling bridge 202 to access network 100. Controlling bridge 202 then transmits and receives packets to and from servers 106 by way of a port extender 204. Port extender 204 transmits and receives packets from controlling bridge 202 and transmits and receives packets to and from multiple servers 106 that connect to port extender 204 using multiple ports.

In an embodiment, servers 106 run multiple virtual machines 206 or VMs 206. A virtual machine 206 is a virtual implementation of a physical computing device that emulates the functionalities of a physical computer, such as, an operating system, a computing environment, a particular instance of a program, application or a process, to name a few examples. In an embodiment, multiple instances of virtual machines 206 may execute on a single instance of server 106.

To access network 100, virtual machines 206 are connected to port extenders 204 by way of servers 106. Port extenders 204 aggregate packets generated by virtual machines 206 executing on servers 106 within server racks 102 in order to transmit packets over network 100. Port extenders 204 also disperse the packets that arrive over network 100 to the respective virtual machines 206 connected to port extenders 204. Typically, port extenders 204 have multiple ports, such as MAC ports that receive data traffic from virtual machines 206, with one or more ports assigned to each virtual machine 206 and a single port that connects to an overlay network 208, discussed below.

In an embodiment, port extenders 204 connect to controlling bridges 202. In a way, port extenders 204 extend ports associated with controlling bridges 202 to multiple ports associated with servers 106 and virtual machines 206.

In conventional networks, a conventional port extender has a physical connection to a conventional controlling bridge. For example, a port in the port extender is connected to a port in a conventional controlling bridge using a physical connection, such as a cable. However, in conventional networks when a controlling bridge breaks or becomes inoperable, port extenders that connect to the controlling bridge are unable to send packets to the network or receive packets from the network and propagate these packets to the virtual machines. Additionally, when multiple port extenders are physically connected to a controlling bridge and propagate a large number of packets, the controlling bridge may become a data bottleneck that prevents efficient flow of packets to and from the network.

Unlike conventional networks, FIG. 2A includes overlay network 208. Overlay network 208 is a virtual network built on top of a physical network that connects port extenders 204 and controlling bridges 202 and allows multiple port extenders 204 to connect to multiple controlling bridges 202. For instance, port extender 204 connects to overlay network 208 using a virtual link 210, and controlling bridge 202 connects to overlay network 208 using virtual link 212. Virtual link 210 and virtual link 212 connect to overlay network 208 using virtual ports. Once connected, packets travels upstream from multiple port extenders 204 to multiple controlling bridges 202 and downstream from multiple controlling bridges 202 to multiple port extenders 204.

A combination of virtual links 210 and 212 create a virtual tunnel (also referred to as tunnel) that may correspond to a path through one or more physical links in the underlying physical network. FIG. 2B is a block diagram 200B of physical connections and virtual tunnels between port extenders and controlling bridges, according to an embodiment. In FIG. 2B, port extender 204A physically connects to controlling bridge 202A, port extender 204B physically connects to a controlling bridge 202B, and controlling bridges 202A and 202B are physically connected. This is indicated by the solid lines which represent physical connections from controlling bridge 202A to port extender 204A, controlling, bridge 202B to port extender 204B, and controlling bridge 202A to controlling bridge 202B. These physical connections are overlaid with overlay network 208 and are physical paths through which packets travel. For example, overlay network 208 includes a tunnel from port extender 204A to controlling bridge 202B through virtual link 210A that links port extender 204A to overlay network 208 and virtual link 21213 that links to controlling bridge 202B to overlay network 208. For packets to travel through the tunnel, packets actually travel through the underlying physical network between port extenders 204 and controlling bridges 202. For example, for packets to travel through the tunnel from port extender 204A to controlling bridge 202B, packets use physical connections and travel from port extender 204A to controlling bridge 202A and then to controlling bridge 202B and vice versa.

In another example, a tunnel exists between port extender 204A and controlling bridge 202A in overlay network 208 using link 210A from port extender 204A to overlay network 208 and link 212A between controlling bridge 202A and overlay network 208. To use this tunnel, packets travel through a physical connection between port extender 204A and controlling bridge 202A.

Unlike a conventional system where a conventional port extender physically connects to a conventional controlling bridge, overlay network 208 allows port extender 204 to use tunnels to virtually connect to multiple controlling bridges 202. As a result when one controlling bridge 202 malfunctions and loses connection to network 100, packets can be rerouted to another controlling bridge 202 without physically changing connections between port extender 204 and the malfunctioning controlling bridge 202. Overlay network 208 also load balances packets between port extenders 204 and controlling bridges 202. This offloads packets from a particular controlling bridge 202, where packets would otherwise create a bottleneck, and allows for efficient transfer of packets to network 100.

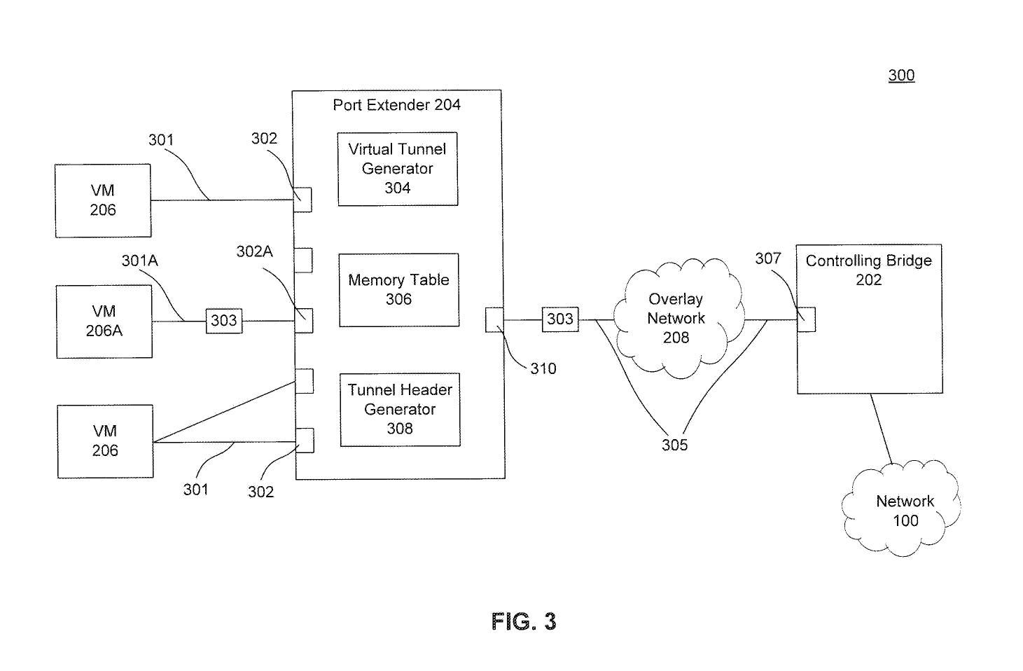

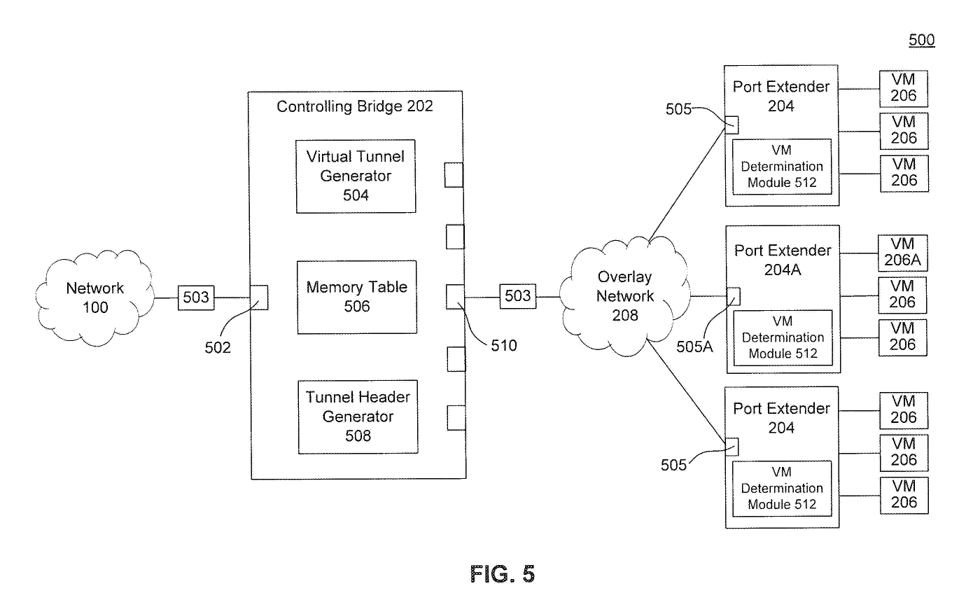

Going back to FIG. 2A, in an embodiment, overlay network 208 includes data-link layer or network layer tunnels that connect port extenders 204 and controlling bridges 202. The connection depends on a type of a tunnel, a type of overlay network 208 and a protocol associated with the tunnel, though the implementation is not limited to this embodiment. For example, in some embodiments port extenders 204 and controlling bridges 202 may store virtual tables that include mappings of tunnels in memory tables between port extenders 204 and controlling bridges 202 as discussed in FIGS. 3 and 5. The packets that travel through these tunnels may then be appended with tunnel headers that fit the configuration of a particular protocol associated with the tunnel and overlay network 208. Example tunnels include a General Routing Encapsulation (GRE) tunnels, Virtual Extensible LAN (VXLAN) tunnels, Transparent Interconnection of Lots of Links (TRILL) tunnels or Shortest Path Bridging (SPB) tunnels, though an implementation is not limited to these embodiments. A GRE is a tunneling protocol that encapsulates a variety of network layer protocols inside virtual point-to-point links over an Internet Protocol (IP) internetwork, and is known to a person of ordinary skill in the art. A VXLAN is an encapsulation protocol used over an existing network layer infrastructure, and is also known to a person of ordinary skill in the art. A TRILL is an IETF (Internet Engineering Task Force) standard implemented using routing bridges or switches. In TRILL the switches run a link-state protocol between each other where the connectivity between switches is broadcast to other switches in the TRILL network. This allows the switches in the TRILL network to know about the connectivity of other switches in the TRILL network. A TRILL network is also known to a person of ordinary skill in the art. A SPB is a protocol specified in the IEEE 802.1aq standard that enables multipath routing, such that packets may be transmitted from a source to a destination over multiple, equal cost path, and is also known to a person of ordinary skill in the art.

In an embodiment, port extenders 204 and controlling bridges 202 map the source and/or destination of packets that are propagated though overlay network 208. For example, when a packet from virtual machine 206 arrives at port extender 204, prior to transmitting the packet over overlay network 208, port extender 204 assigns a virtual port to the packet where the virtual port corresponds to a port on a particular controlling bridge 202. Similarly, when controlling bridge 202 receives a packet from network 100, controlling bridge 202 maps the packet to a particular port extender 204 that is connected to virtual machine 206 that is the destination for the packet.

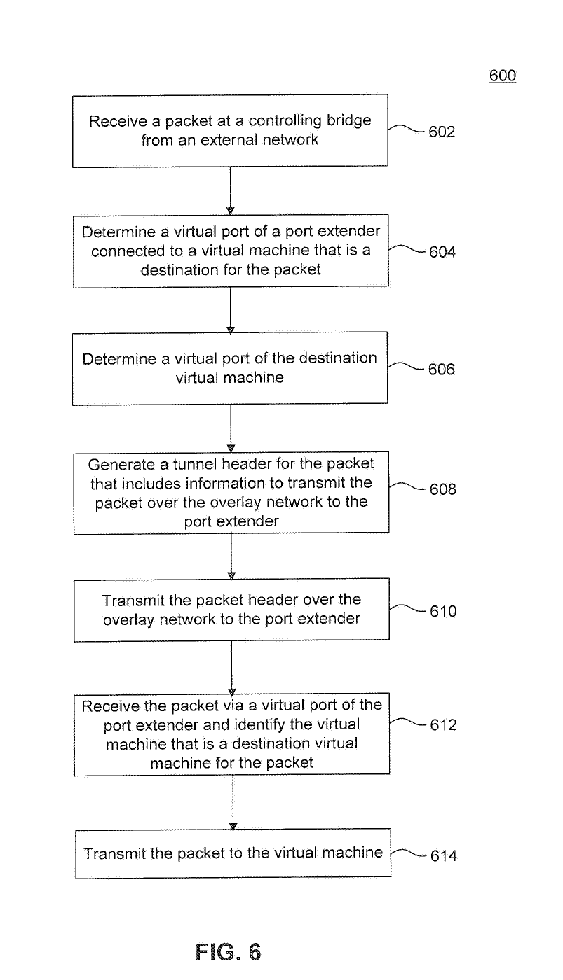

FIG. 3 is a block diagram 300 of a port extender that transmits packets over an overlay network, according to an embodiment. As discussed above, an overlay network may be an internal network that transmits packets between multiple port extenders and multiple control bridges. In an embodiment, an overlay network transmits packets before packets enter an external network, such as a cloud network or network 100 that transmits packets to a destination server 106 or virtual machine 206. In another embodiment, discussed with reference to FIGS. 5 and 6 below, an overlay network may transmit packets after packets arrive from network 100 to a controlling bridge and then to one of multiple port extenders that are connected to a destination server 106 or virtual machine 206.

In an embodiment, virtual machines 206 connect to port extender 204 using virtual links 301. For example, virtual machine 206A connects to port extender 204 using virtual link 301A. Virtual links 301 may be logical links. Link 301 may be associated with a virtual port 302 that connects virtual machine 206 to port extender 204. For example, virtual machine 206A transmits a packet, such as packet 303, through link 301A and is associated with virtual port 302A. A person skilled in the art will appreciate that virtual links 301 and virtual ports 302 use memory mapping to map virtual machines 206 to port extender 204 instead of physical wire connections.

Prior to transmitting an exemplary packet 303 through overlay network 208 to controlling bridge 202, port extender 204 creates a virtual tunnel and a tunnel header for packet 303. A virtual tunnel, such as an exemplary virtual tunnel 305 allows packet 303 to travel from port extender 204 to controlling bridge 202 through overlay network 208. A tunnel header stores source and destination information of where packet 303 originated and where packet 303 is being transmitted to, and allows packet 303 to travel through overlay network 208.

In an embodiment, a virtual tunnel generator 304 generates a virtual tunnel, such as virtual tunnel 305. Virtual tunnel 305 connects port extender 304 to a particular controlling bridge 202. Although not shown in FIG. 3, port extender 204 may connect to multiple controlling bridges 202 via overlay network 208.

In an embodiment, virtual tunnel 305 includes two virtual ports: a source virtual port and a destination virtual port. A source virtual port is a virtual port from which packet 303 begins to travel through virtual tunnel 305. A destination virtual port is a virtual port through which packet 303 completes travel through virtual tunnel 305. In an embodiment, a source port in FIG. 3 may be a virtual port connecting virtual machine 206 to port extender 204, such as virtual port 302A, and a destination virtual port may be virtual port 307 of controlling bridge 202. Virtual ports 302A and 307 form end points of virtual tunnel 305 that allows packet 303 to travel through overlay network 208.

In an embodiment, virtual tunnel generator 304 may connect virtual port 302A to virtual port 307 in a one-to-one mapping.

In an embodiment, to generate a virtual tunnel, such as virtual tunnel 305, virtual tunnel generator 304 may first determine a source virtual port of virtual machine 206, such as virtual port 302A of virtual machine 206A based on packet properties. The packet properties may be included within packet 303 and include an IP address associated with virtual machine 206, MAC address (media access control address) of server 106, or another identifier associated with virtual machine 206, though the implementation is not limited to this embodiment. For example, packet 303 that arrives from VM 206A may be assigned to virtual port 302A, based on an identifier associated with virtual machine 206A.

In an exemplary implementation using a GRE network, packet 303 may include an STAG. The STAG includes an IP address of a virtual machine 206, such as virtual machine 206A that generated packet 303 (not shown). Virtual tunnel generator 304 may then associate virtual port 302A with virtual machine 206A based on the IP address of virtual machine 206A.

In an embodiment, virtual tunnel generator 304 may determine a virtual port of a controlling bridge based on virtual port 302A. For example, port extender 204 may include a programmable memory table, such as memory table 306. Memory table 306 includes a mapping of virtual ports 302 associated with virtual machines 206 to virtual ports of controlling bridges 202. In an embodiment, the mapping of virtual ports 302 associated with virtual machines 206 to virtual ports associates with controlling bridges 202 may be a one-to-one mapping. For example, memory table 306 may map virtual port 302A to virtual port 307 of controlling bridge 202.

In an embodiment, a destination virtual port, such as virtual port 307 of controlling bridge, may be associated with a tunnel header used to transmit packet 303 through overlay network 208. A tunnel header associated with a virtual port of a particular controlling bridge 202, may include information that routes packet 303 through overlay network 208.

In an embodiment, memory table 306 may be preconfigured to include a mapping or have a mapping that may be reconfigured at will by a network administrator. For example, when controlling bridge 202 malfunctions, memory table 306 may be reconfigured such that virtual ports that are associated with virtual machines 206 would be mapped to virtual ports of different controlling bridge(s).

Once virtual tunnel generator 304 determines the virtual header that is required to transmit packet 303 to controlling bridge 202, tunnel header generator 308 of virtual port extender 204 appends the tunnel header to packet 303. As discussed above, overlay network 208 uses the tunnel header to transmit packet 303 from port extender 204 to controlling bridge 202. In an embodiment, tunnel header may include virtual port 302 of virtual machine 206, such as virtual port 302A of virtual machine 206A, an IP address of port extender 204 and an IP address of controlling bridge 202. In a further embodiment, tunnel header generator 308 may append tunnel header to packet 303, generate a tunnel header from information in memory table 206 or include information in the tunnel header into the packet header of packet 303 that is used to transmit packet 303 in network 100. Once tunnel header generator 308 appends a tunnel header to packet 303, port extender 204 transmits packet 303 through virtual tunnel 305 in overlay network 208 to virtual port 307 of controlling bridge 202. In an embodiment, packet 303 leaves port extender 204 through a physical port, such as port 310.

In an embodiment, the tunnel header may be in a format that is associated with the type of overlay network 208, such as a VXLAN, GRE, TRILL or SPB type networks. Each of these networks may require different information to transmit packet 303 through overlay network 208. As such, tunnel header generator 308 may populate the information in the tunnel header in accordance with the information required by the respective overlay network 208.

Once controlling bridge 202 receives packet 303, controlling bridge 202 removes the tunnel header used to transmit packet 303 in overlay network 208, and transmits packet 303 over network 100.

In an embodiment, controlling bridge 202 also modifies the contents of the ETAG of packet 303. For example, controlling bridge 202 populates the destination field in the ETAG with a destination server 106 or virtual machine 206 of packet 303 in network 100. In another example, controlling bridge 202 also populates the source field of ETAG with an IP address of controlling bridge 206 so that network 100 will interpret that controlling bridge 202 is a source of packet 303.

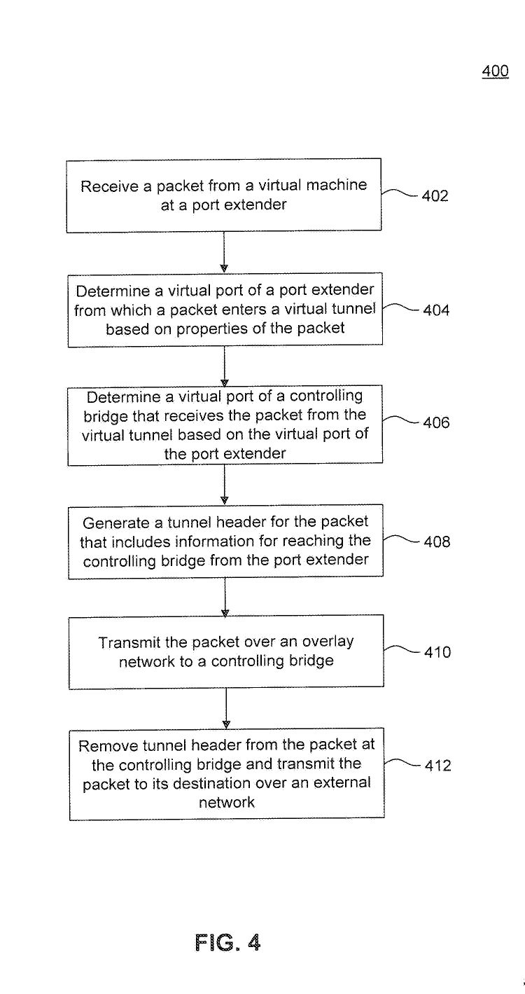

FIG. 4 is a flowchart of a method 400 for transmitting a packet over an overlay network from a port extender to a controlling bridge, according to an embodiment.

At stage 402, a packet arrives at a port extender. For example, port extender 204 receives packet 303 from virtual machine 206A connected to port extender 204 using link 301A and associated with, virtual port 302A.

At stage 404, a virtual port of a virtual machine that is the source a packet is determined. For example, virtual tunnel generator 304 may determine that packet 303 arrived from virtual machine 206A that is associated with virtual port 302A. In an embodiment, virtual tunnel generator 304 may determine virtual port 302A for packet 303 based on the packet properties included in packet 303. Example packet properties may include an identifier of virtual machine 206A or an IP address associated with virtual machine 206A. As discussed above, virtual port 302A may be a source virtual port of virtual tunnel 305 that transmits packet 303 through overlay network 208.

At stage 406, a virtual port of a controlling bridge that receives the packet is determined. For example, virtual tunnel generator 304 determines that virtual port 307 of controlling bridge 202 will receive packet 303. Virtual tunnel generator 304 may use memory table 306 that maps virtual ports 302 of virtual machines 206 to virtual ports of controlling bridge 202, and determine that virtual port 302A maps to virtual port 307 of controlling bridge 202.

At stage 408, a tunnel header is generated. For example, once virtual port generator 304 determines a virtual port of controlling bridge 202 in step 406, virtual port generator 304 may map the virtual port of controlling bridge 202 to a tunnel header stored in memory table 306. The tunnel header may then be retrieved from memory table 306 and appended to packet 303 or included into packet header of packet 303. Alternatively, a tunnel header may be generated an information from memory table 306 may be copied into the tunnel header. The tunnel header includes the virtual port 302 associated with virtual machine 206A and virtual port 307 associated with controlling bridge 202 that form end points for virtual tunnel 305.

At stage 410, a packet is transmitted over an overlay network. For example, once a tunnel header is appended to packet 303, port extender 204 transmits packet 303 to controlling bridge 202 associated with the information in the tunnel header.

At stage 412, a packet is received at a controlling bridge. For example, controlling bridge 202 that receives packet 303, removes the tunnel header from packet 303, and transmits packet 303 to its destination over network 100.

In an embodiment, controlling bridge 202 also receives packets from network 100. Once controlling bridge 202 receives packets from network 100, controlling bridge 202 uses overlay network 208 to forward packet 303 to server 106 or virtual machine 206 that is a destination for packet 303. FIG. 5 is a block diagram 500 of a controlling bridge that transmits a packet over an overlay network, according to an embodiment.

When packet 503 arrives at controlling bridge 202 via physical port 502, controlling bridge 202 transmits packet 503 to the destination virtual machine 206. In an embodiment, controlling bridge 202 transmits packet 503 using a virtual tunnel through overlay network 208. To transmit packet 503 through overlay network 208, controlling bridge 202 first determines a destination virtual port. The destination virtual port can be a virtual port 505 of port extender 204 associated with virtual machine 206 that is the destination for packet 503. In example FIG. 5, the destination virtual port 505 may be virtual port 505A.

To determine virtual port 505 of port extender 204, controlling bridge 202 includes a virtual tunnel generator 504 and a memory table 506. Virtual tunnel generator 504 determines virtual port 505 associated with port extender 204 that will receive packet 503 over overlay network 208, such as virtual port 505A of port extender 204A. Memory table 506 stores different mappings of information required to transmit packet 503 over overlay network 208, as described below.

To determine the virtual port 505, virtual tunnel generator 504 determines virtual machine 206 that is a destination of packet 503, using, for example, data link layer or network layer data included in packet 503. Example data link layer or network layer data may include a destination IP address of virtual machine 206 or MAC address of server 106 that is a destination for packet 503. Once virtual tunnel generator 504 retrieves the data link layer or network layer data, virtual tunnel generator 504 accesses memory table 506. Memory table 506 stores information that associates destination IP address or MAC address with virtual port 505, such as virtual port 505A of port extender 204A that receives packet 503 from controlling bridge 202 over overlay network 208.

In an embodiment, virtual port 505 also maps to additional information required to transmit packet 503 in overlay network 208. This additional information may include STAG information that includes a virtual port of virtual machine 206, such as virtual machine 206A that is a destination of packet 503 and an IP address of controlling bridge 202. Additionally, the additional information may include tunnel header information required to transmit packet 503 over overlay network 208. Example tunnel header information may include an IP address of port extender 204.

Once virtual tunnel generator 504 determines virtual port 505 of port extender 204, virtual tunnel generator 504 generates a virtual tunnel between controlling bridge 202 and port extender 204.

In an embodiment, a tunnel header generator 508 also attaches or constructs a tunnel header to packet 503. The tunnel header permits packet 503 to be transmitted within overlay network 208 from controlling bridge 202 to port extender 204. As discussed above, tunnel header includes information retrieved from memory table 506, such as IP address of port extender 204. Additionally, tunnel header generator 508 may rewrite fields in the ETAG of packet 503 to include a virtual port of virtual machine 206 that is a destination of packet 503.

In an embodiment, the tunnel header may be in a format that is associated with the type of overlay network 208, such as a VXLAN, GRE, TRILL or SPB type networks. Each of these networks may require different information to transmit packet 503 through overlay network 208. As such, tunnel header generator 508 may populate the information in the tunnel header in accordance with the information required by the respective overlay network 208.

Once tunnel header generator 508 attaches a tunnel header to packet 503, controlling bridge 202 transmits packet 503 over overlay network 208 using, for example, a physical port 510. Packet 503 travels through the virtual tunnel in overlay network 208 to virtual port 505A of port extender 204A as designated in the tunnel header.

When port extender 204A receives packet 503 via overlay network 208, port extender 204A removes the tunnel header from packet 503. Port extender 204 then uses VM determination module 512 to determine which virtual machine out of virtual machines 206 that are connected to port extender 204A is a destination virtual machine 206 for packet 503. To determine virtual machine 206 that is a destination for packet 503, VM determination module 512 may retrieve the ETAG that controlling bridge 202 included or modified in packet 503. As discussed, the ETAG stores the virtual port of destination virtual machine 206, such as virtual machine 206A. VM determination module 512 then uses the virtual port of virtual machine 206 to determine virtual machine 206A through a mapping in a memory table of port extender 204 (not shown). Once virtual machine 206A is identified, port extender 204 forwards packet 503 to virtual machine 206A using the associated virtual port 206A. In another embodiment, port extender 204 may also use data link layer or network layer information in packet 503 to map packet 503 to virtual machine 206.

FIG. 6 is a flowchart of a method 600 for transmitting a packet over an overlay network from a controlling bridge to a port extender, according to an embodiment.

At stage 602, a packet arrives at a controlling bridge. For example, controlling bridge 202 receives packet 503 from network 100 through port 502.

At stage 604, a virtual port of a port extender is determined. For example, example, virtual tunnel generator 504 uses a destination IP address or MAC address included in data link layer or network layer of packet 503 to look up virtual port 505 of port extender 204 in memory table 506.

At stage 606, a virtual port of a virtual machine is determined. For example virtual tunnel generator 504 may also map virtual port 505 of port extender 204 along with a destination IP address or MAC address in packet 503 to determine a virtual port of virtual machine 206, such as virtual machine 206A that is a destination of packet 503.

At stage 608, a tunnel header is generated. For example, tunnel header generator 508 generates a tunnel header for packet 503. As discussed above, tunnel header includes information retrieved from memory table 506, such as, IP address of port extender 204A. Additionally, tunnel header generator 508 may rewrite fields in the ETAG of packet 503 to include a virtual port of virtual machine 206 that is a destination of packet 503.

At stage 610, a packet is transmitted over an overlay network. For example, once a tunnel header is appended to packet 503, controlling bridge 202 transmits packet 503 to port extender 204 through a virtual tunnel in overlay network 208 that ends at virtual port 505A of port extender 204A. As discussed above, packet 503 may enter overlay network 208 through physical port 510.

At stage 612, a packet is received by a port extender. For example, port extender 204A associated with virtual port 505A in the tunnel header receives packet 503. Once received. VM determination module 512 of port extender 204A removes the tunnel header and uses the packet properties, such as information in the ETAG of packet 503 to obtain the virtual port of virtual machine 206, such as virtual machine 206A, that is a destination for packet 503. VM determination module 512 then uses the virtual port of virtual machine 206 to determine virtual machine 206A through a mapping in a memory table of port extender 204A.

At stage 614, a packet is transmitted to a virtual machine. Once VM determination module 512 identifies virtual machine 206A, port extender 204 transmits packet 503 to virtual machine 206A.

Various aspects of the disclosure can be implemented by software, firmware, hardware, or a combination thereof. FIG. 7 illustrates an example computer system 700 in which the embodiments, or portions thereof, can be implemented. For example, the methods illustrated by flowcharts described herein can be implemented in system 700. Various embodiments of the disclosure are described in terms of this example computer system 700. After reading this description, it will become apparent to a person skilled in the relevant art how to implement the disclosure using other computer systems and/or computer architectures.

Computer system 700 includes one or more processors, such as processor 710. Processor 710 can be a special purpose or a general purpose processor. Processor 710 is connected to a communication infrastructure 720 (for example, a bus or network).

Computer system 700 also includes a main memory 730, preferably random access memory (RAM), and may also include a secondary memory 740. Secondary memory 740 may include, for example, a hard disk drive 750, a removable storage drive 760, and/or a memory stick. Removable storage drive 760 may comprise a floppy disk drive, a magnetic tape drive, an optical disk drive, a flash memory, or the like. The removable storage drive 760 reads from and/or writes to a removable storage unit 770 in a well-known manner. Removable storage unit 770 may comprise a floppy disk, magnetic tape, optical disk, etc. which is read by and written to by removable storage drive 760. As will be appreciated by persons skilled in the relevant art(s), removable storage unit 770 includes a computer usable storage medium having stored therein computer software and/or data.

In alternative implementations, secondary memory 740 may include other similar means for allowing computer programs or other instructions to be loaded into computer system 700. Such means may include, for example, a removable storage unit 770 and an interface (not shown). Examples of such means may include a program cartridge and cartridge interface (such as that found in video game devices), a removable memory chip (such as an EPROM, or PROM) and associated socket, and other removable storage units 770 and interfaces which allow software and data to be transferred from the removable storage unit 770 to computer system 700.

Computer system 700 may also include a communications and network interface 780. Communication and network interface 780 allows software and data to be transferred between computer system 700 and external devices. Communications and network interface 780 may include a modern, a communications port, a PCMCIA slot and card, or the like. Software and data transferred via communications and network interface 780 are in the form of signals which may be electronic, electromagnetic, optical, or other signals capable of being received by communication and network interface 780. These signals are provided to communication and network interface 780 via a communication path 785. Communication path 785 carries signals and may be implemented using wire or cable, fiber optics, a phone line, a cellular phone link, an RF link or other communications channels.

The communication and network interface 780 allows the computer system 700 to communicate over communication networks or mediums such as LANs, WANs the Internet, etc. The communication and network interface 780 may interface with remote sites or networks via, wired or wireless connections.

In this document, the terms “computer program medium” and “computer usable medium” and “computer readable medium” are used to generally refer to media such as removable storage unit 770, removable storage drive 760, and a hard disk installed in hard disk drive 750. Signals carried over communication path 785 can also embody the logic described herein. Computer program medium and computer usable medium can also refer to memories, such as main memory 730 and, secondary memory 740, which can be memory semiconductors (e.g. DRAMs, etc.). These computer program products are means for providing software to computer system 700.

Computer programs (also called computer control logic) are stored in main memory 730 and/or secondary memory 740. Computer programs may also be received via communication and network interface 780. Such computer programs, when executed, enable computer system 700 to implement embodiments of the disclosure as discussed herein. In particular, the computer programs, when executed, enable processor 710 to implement the processes of the disclosure, such as the steps in the methods illustrated by flowcharts discussed above. Accordingly, such computer programs represent controllers of the computer system 700. Where the disclosure is implemented using software, the software may be stored in a computer program product and loaded into computer system 700 using removable storage drive 760, hard drive 750 or communication and network interface 780, for example.

The computer system 700 may also include input/output/display devices 790, such as keyboards, monitors, pointing devices, etc.

The disclosure is also directed to computer program products comprising software stored on any computer useable medium. Such software, when executed in one or more data processing device(s), causes a data processing device(s) to operate as described herein. Embodiments of the disclosure employ any computer useable or readable medium, known now or in the future. Examples of computer useable mediums include, but are not limited to primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

Embodiments in the disclosure can work with software, hardware, and/or operating system implementations other than those described herein. Any software, hardware, and operating system implementations suitable for performing the functions described herein can be used.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A system for transmitting packets, comprising:
a plurality of port extenders within a server rack configured to receive a packet from a server in the server rack;
a plurality of controlling bridges configured to transmit the packet over a network outside of the server rack; and
an overlay network configured on top of a physical network between the plurality of port extenders and the plurality of controlling bridges and configured to:
connect, using a virtual tunnel, a port extender in the plurality of port extenders to a controlling bridge in the plurality of controlling bridges, wherein the port extender and the controlling bridge do not have a direct physical connection; and
transmit, using the virtual tunnel, the packet between the port extender and the controlling bridge.

2. The system of claim 1, wherein to determine the virtual tunnel the port extender is further configured to:
map properties associated with the packet to determine a source virtual port of the virtual tunnel;
determine a destination virtual port associated with the controlling bridge based on the mapping to the source virtual port; and
transmit the packet to the controlling bridge through the virtual tunnel beginning at the source virtual port and ending at the destination virtual port.

3. The system of claim 2, wherein the port extender is further configured to:
generate a header for the packet, wherein the header identifies the address of the controlling bridge and facilitates the packet transmission over the overlay network.

4. The system of claim 1, wherein the overlay network uses a data link layer or a network layer to transmit the packet.

5. The system of claim 1, wherein the overlay network is a virtual network built on top of the physical network such that the overlay network virtually connects the port extender to the controlling bridge without a one to one connection between the port extender and the controlling bridge.

6. The system of claim 1, wherein the controlling bridge is further configured to:
receive the packet; and
transmit the packet over the network outside of the servers in the server rack.

7. The system of claim 1, wherein the controlling bridge is further configured to:
receive a second packet from the network outside of the server rack;
map properties associated with the second packet to determine a virtual port of a second port extender that is associated with a destination address of the second packet;
generate a second virtual tunnel between the controlling bridge and the second port extender based on the mapping; and
transmit the second packet to the second port extender associated with the virtual port over the second virtual tunnel in the overlay network.

8. The system of claim 7, wherein the properties include at least a destination Internet Protocol (IP) address of the second packet.

9. The system of claim 7, wherein the controlling bridge is further configured to:
generate a header for the second packet, wherein the header includes an IP address associated with the second port extender connected to a logical or physical computing device that is a destination of the second packet, and wherein the header facilitates the second packet transmission through the overlay network to the second port extender.

10. The system of claim 7, wherein the second port extender is further configured to:
receive the second packet using the virtual port of the port extender; and
transmit the second packet to a logical or physical computing device that is a destination or the second packet.

11. A method of transmitting packets, comprising:
providing an overlay network for transmitting, a packet between a plurality of controlling bridges and a plurality of port extenders within a server rack, wherein a port extender connects to multiple servers in the server rack and a controlling bridge transmits the packet over a network outside of the servers in the server rack;
providing a mapping between the port extender and the controlling bridge in the plurality of controlling bridges, wherein the mapping enables the packet to travel in the overlay network between the port extender and the controlling bridge; and
transmitting the packet over the overlay network according to the mapping.

12. The method of claim 11, wherein providing the mapping further comprises:
receiving the packet at the port extender;
mapping properties associated with the packet to determine a source virtual port of a virtual tunnel;
selecting a destination virtual port of the virtual tunnel based on the source virtual tunnel, wherein the destination virtual port is associated with the controlling bridge; and
wherein the transmitting further comprises transmitting the packet from the port extender to the controlling bridge using the virtual tunnel in the overlay network.

13. The method of claim 12, further comprising:
generating a header for the packet, wherein the header includes the address of the controlling bridge and facilitates the packet transmission over the overlay network.

14. The method of claim 12, further comprising:
receiving the packet at the controlling bridge; and
transmitting the packet over the network outside of the servers in the server rack.

15. The method of claim 11, wherein the overlay network uses a data link layer or a network layer to transmit the packet.

16. The method of claim 11, wherein the overlay network is a virtual network built on top of a physical network.

17. The method of claim 11, further comprising:
receiving a second packet from the network outside of the server rack;
mapping properties associated with the second packet to determine a virtual port of a second port extender that is associated with a destination address of the second packet;
generating a second virtual tunnel between the controlling bridge and the second port extender based on the mapping; and
transmitting the second packet to the second port extender associated with the virtual port over the second virtual tunnel in the overlay network.

18. The method of claim 17, wherein the properties include at least a destination Internet Protocol (IP) address of the second packet.

19. The method of claim 17, further comprising:
generating a header for the second packet, wherein the header includes an Internet Protocol (IP) address associated with the second port extender connected to a logical or physical computing device that is a destination of the packet.

20. The method of claim 17, further comprising:
receiving the second packet using the virtual port of the port extender; and
transmitting the second packet to a logical or physical computing device that is a destination of the second packet.
